(19) United States
(12) Patent Application Publication
(10) Pub. No.: US 2026/0361015 A1
(43) Pub. Date: Nov. 12, 2026

(54) ELECTRICAL CONNECTOR WITH IMPROVED POWER TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: CHENG-HAO LV, Kunshan (CN); YUNG-CHIH HUNG, New Taipei (TW); ZHI-BIN ZHAO, Kushan (CN)

(21) Appl. No.: 19/662,281

(22) Filed: Apr. 29, 2026

(30) Foreign Application Priority Data
May 7, 2025 (CN) 202510579974.8

(51) Int. Cl. H01R 13/11

(52) U.S. Cl. CPC H01R 13/11

(57) ABSTRACT

An electrical connector includes: an insulating housing; and a power terminal comprising a first, a second, and a third terminal pieces; wherein: the first terminal piece has a first base, plural first elastic arms and first contact portions; the second terminal piece has a second base, plural second elastic arms and second contact portions; the third terminal piece has a third base, plural third elastic arms and third contact portions; the first, second, and third bases are stacked and fixed in the insulating housing; the first, second, and third contact portions are each arranged in a row; the second contact portions are aligned one-to-one with the third contact portions; each of the first contact portions is aligned with one of two adjacent second contact portions; and a spacing between adjacent first elastic arms is greater than a width of the second elastic arm in the first direction.

### BACKGROUND OF THE INVENTION

### 1. Field of the Invention

The present invention relates generally to an electrical connector, and particularly to an electrical connector for transmitting large currents.

### 2. Description of Related Arts

A power supply unit (PSU) is a power conversion device for converting alternating current (AC) into stable direct current (DC). The DC power is then supplied to the motherboard via the gold fingers of a connector plate. The motherboard has a mating edge-type power connector. Currently, greater power is achieved by increasing the number of metal plates at each terminal and connecting them in parallel to increase the current. U.S. Pat. No. 10,637,175 discloses an electrical connector having a first terminal and a second terminal, a first pin and a second pin of the first terminal pass through a plastic connecting block and connect to a third pin and a fourth pin of the second terminal. The connecting block connects the individual pins into a whole, forming a modular terminal, thereby enhancing the overall connection stability of the terminal. However, as the transmitted current increases, the temperature will inevitably increase, and the fact that the four pins are embedded in the connecting block relatively weakens the heat dissipation effect.

An improved electrical connector is desired.

### SUMMARY OF THE INVENTION

An object of the present invention is to provide an electrical connector with improved power terminals.

To achieve the above-mentioned object, an electrical connector comprises: an insulating housing; and a power terminal comprising a first, a second, and a third terminal pieces; wherein: the first terminal piece comprises a first base portion, plural first elastic arms and first contact portions; the second terminal piece comprises a second base portion, plural second elastic arms and second contact portions; the third terminal piece comprises a third base portion, plural third elastic arms and third contact portions; the first, second, and third base portions are stacked and fixed in the insulating housing; the first, second, and third contact portions are each arranged in a row; the second contact portions are aligned one-to-one with the third contact portions; each of the first contact portions is aligned with one of two adjacent second contact portions; and a spacing between adjacent first elastic arms is greater than a width of the second elastic arm in the first direction.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of an electrical connector of an embodiment of the present invention;

FIG. 2 is another perspective view of the electrical connector in FIG. 1;

FIG. 3 is an exploded perspective view of FIG. 1;

FIG. 4 is a perspective view of an upper power terminal in FIG. 3;

FIG. 5 is a perspective view of a first terminal piece in FIG. 4;

FIG. 6 is a perspective view of a second terminal piece in FIG. 4;

FIG. 7 is a perspective view of a third terminal piece in FIG. 4;

FIG. 8 is a bottom view of FIG. 4;

FIG. 9 is a perspective view of a lower power terminal in FIG. 3;

FIG. 10 is an exploded perspective view of FIG. 9; and

FIG. 11 is a top view of FIG. 9.

### DETAILED DESCRIPTION OF THE PREFERRED EMBODIMENT

Reference will now be made to the drawing figures to describe the preferred embodiment of the present invention in detail.

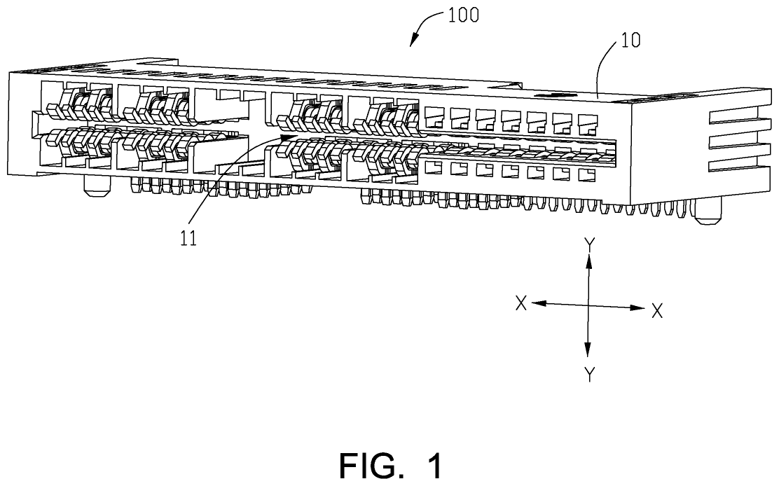

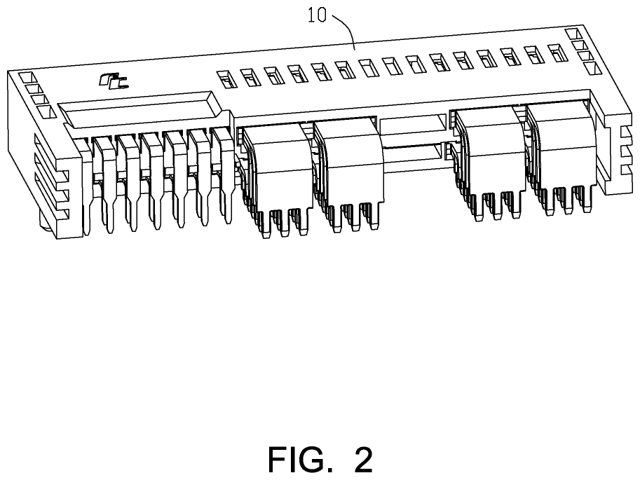

An electrical connector is used for transmitting large currents, particularly for use as a power input interface in a power supply unit (PSU). Referring to FIGS. 1-3, the electrical connector 100 has an insulating housing 10 and at least one power terminal 20P. The insulating housing has a mating slot 11 for receiving a card-type transmission interface. The mating slot 11 is elongated and extends in a first direction X-X, i.e., a longitudinal direction. The power terminal 20P is disposed on one side of the mating slot 11 along a second direction Y-Y perpendicular to the first direction X-X, i.e., a lateral direction.

In this embodiment, the electrical connector 100 comprises four power terminals 20P and a plurality of signal terminals 20S. The mating slot 11 is divided into a power mating slot 11P and a signal mating slot 11S. A plurality of terminal holes are located on opposite sides of the mating slot in the second direction and has power terminal holes 12P and signal terminal holes 12S for receiving the corresponding terminals. The signal terminals 20S are arranged in two rows and are located on opposite sides of the signal mating slot 11S in the second direction. One pair of power terminals 20P are respectively positioned on opposite sides of the power mating slot 11P and are aligned with each other, and are used for transmitting the positive power supply. Another pair of power terminals are also respectively positioned on opposite sides of the power mating slot 11P, aligned with each other, and used for transmitting the negative power supply. The two power terminals in each pair have substantially a same structure. The electrical connector 100 is a right-angle connector, and the two power terminals are arranged vertically. The two power terminals are arranged vertically, with the rear ends differing to mate with a circuit board, while the front ends are substantially the same. In a vertical connector, a pair of power terminals are arranged vertically and may have a same structure. Meanwhile, the terms first, second, and third used below are only for distinguishing different elements and do not indicate any order or sequence.

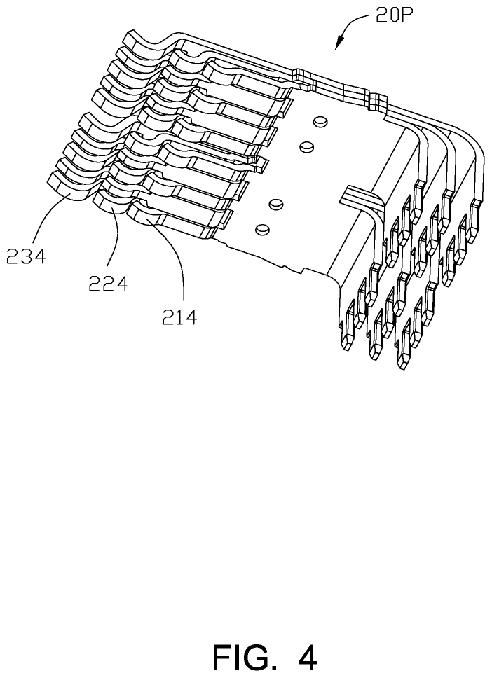

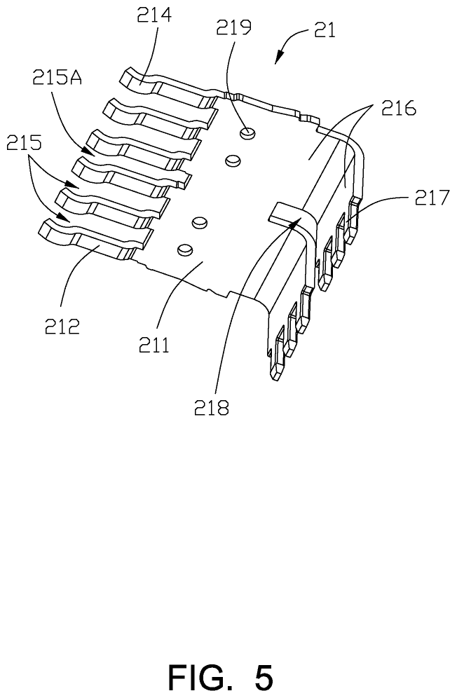

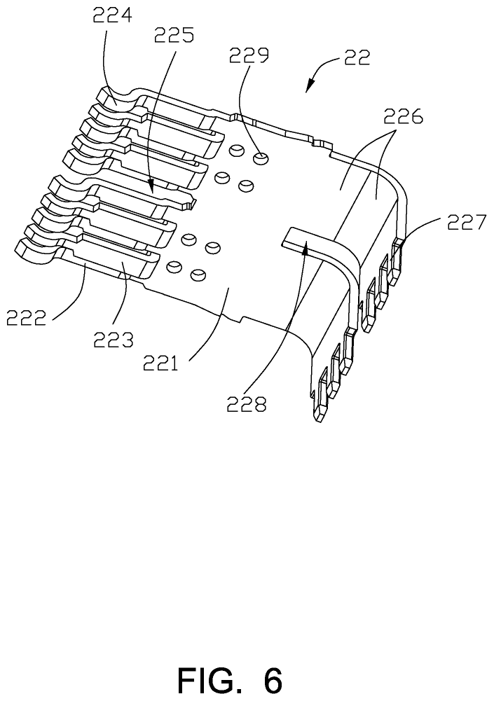

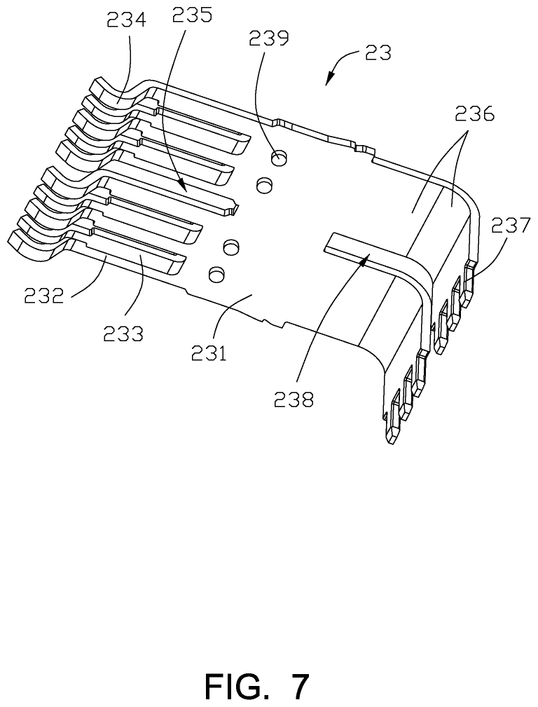

Referring to FIGS. 4-8, an upper-row power terminal is selected for description. The power terminal 20P has a first terminal piece 21, a second terminal piece 22, and a third terminal piece 23. The first terminal piece 21 has a first base portion 211, a plurality of first elastic arms 212 extending from the first base portion, and a first contact portion 214 curvedly bent from a distal end of each first elastic arm. The second terminal piece 22 has a second base portion 221, a plurality of second elastic arms 222, 223 extending from the second base portion, and a second contact portion 224 curvedly bent from a distal end of each second elastic arm. The third terminal piece 23 has a third base portion 231, a plurality of third elastic arms 232, 233 extending from the third base portion, and a third contact portion 234 curvedly bent from a distal end of each third elastic arm. The first base portion 211, the second base portion 221, and the third base portion 231 are stacked from an inside to an outside of the mating slot 11 in the second direction and are fixed in the insulating housing 10. A plurality of first contact portions 214 are arranged in a rear row, a plurality of second contact portions 224 are arranged in a middle row, and a plurality of third contact portions 234 are arranged in a front row. When viewed in the mating direction, the second contact portions 224 are located inside the third contact portions 234 and are aligned one-to-one with the third contact portions 234. The first contact portions 214 are located inside the second contact portions 224, and each first contact portion 214 is aligned with one of the adjacent second contact portions 224. In the present invention, the contact portions of each power terminal 20P are arranged in three rows in a staggered manner. Within the limited size of the metal plates, the conductive area is maximized to increase the current-carrying area, thereby meeting the requirement for high current transmission while minimizing the risk of rapid temperature rise.

In this embodiment, the second elastic arms 222, 223 of the second terminal piece 22 are formed by tearing, so that the gaps between adjacent second elastic arms 222 and 223 are close to zero. The adjacent second elastic arms 222 and 223 are offset from each other in the second direction and arranged in two rows, thereby preventing interference between adjacent second elastic arms during movement. One of each pair of adjacent second elastic arms 222 is aligned one-to-one with the first elastic arms 212 in the second direction. The other one of each pair of adjacent second elastic arms 223 extends between two first elastic arms 212 in the second direction.

Similarly, the third elastic arms 232,233 of the third terminal piece 23 are formed by tearing, so that the gaps between adjacent third elastic arms 232 and 233 are close to zero. The adjacent third elastic arms 232 and 233 are offset from each other in the second direction and arranged in two rows, thereby preventing interference between adjacent third elastic arms during movement. The second and third elastic arms are laterally stacked and aligned with each other, and are spaced apart by a distance in the lateral direction to provide elastic space.

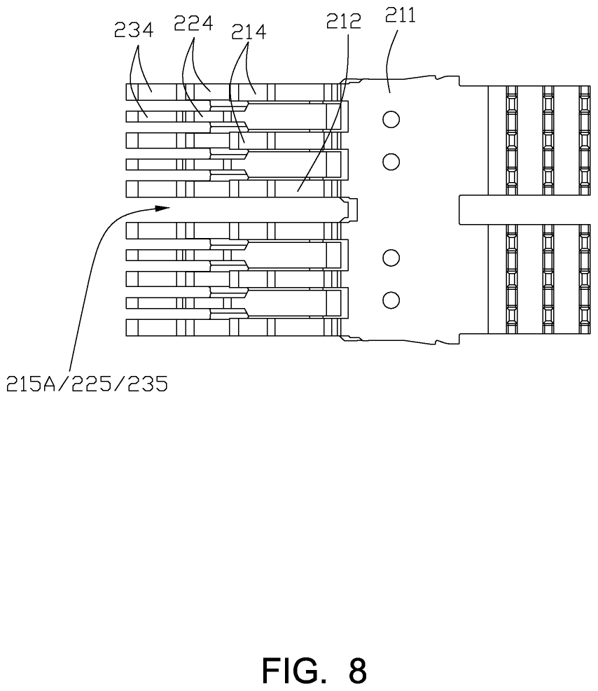

In this embodiment, the first elastic arms 212 of the first terminal piece are formed by stamping. A first vacant portion 215 is located between adjacent first elastic arms. As shown in FIG. 8, a width of the first vacant portion 215 is greater than a width of the first elastic arm 212 in the first direction. Compared with the second and third elastic arms, a number of first elastic arms is less than a number of second elastic arms or the third elastic arms.

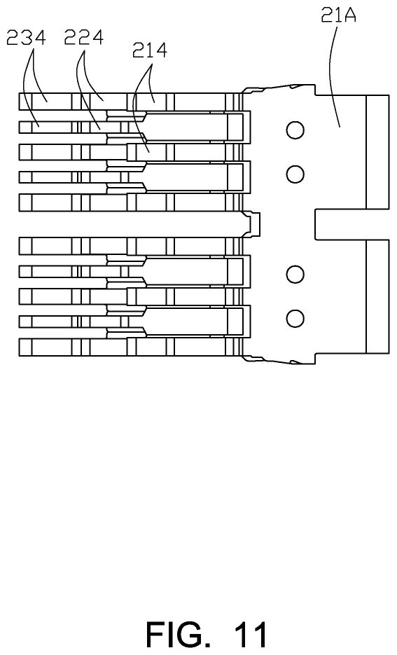

In this embodiment, the first, second, and third contact portions are located at the ends of the first, second, and third elastic arms, respectively, and are formed by stamping. There are gaps between adjacent first, second, and third contact portions. The gaps can prevent interference between adjacent contact portions when a card is inserted. In a specific embodiment, the gaps are generally smaller than the longitudinal dimension of each elastic arm. Referring to FIGS. 8, 11, a longitudinal width of the first elastic arm 212 is less than a longitudinal width of the second elastic arm, and the longitudinal width of the second elastic arm 222 is less than the longitudinal width of the adjacent second elastic arm 223.

In this embodiment, the plurality of second elastic arms 222, 223 are divided into two groups in the first direction by a second vacant portion 225. A width of the second vacant portion 225 is greater than the spacing between adjacent second elastic arms 222, 223 in the first direction. The plurality of third elastic arms 232, 233 are divided into two groups in the first direction by a third vacant portion 235. One of the first vacant portions 215A is aligned with the second vacant portion 225 and the third vacant portion 235 in the second direction.

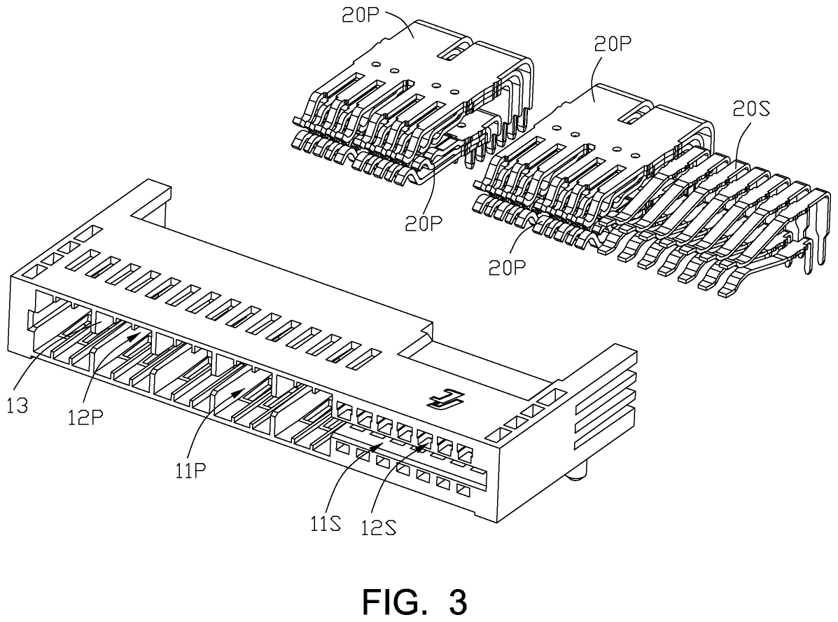

Referring to FIG. 3, furthermore, the insulating housing has a spacer rib 13 positioned within one of the first vacant portions 215A, the second vacant portion 225, and the third vacant portion 235. In this embodiment, the spacer rib 13 is disposed in the power terminal hole 12P and cooperates with the first, second and third vacant portions. In this way, even when there are a large number of elastic arms, improper actuation or displacement of the elastic arms caused by card insertion will not result in linkage between the elastic arms located on both longitudinal sides of the same power terminal.

Furthermore, the second vacant portion 225 is recessed toward the second base portion 221 beyond a root of the second elastic arm 222 to the second base portion. The third vacant portion 235 is recessed toward the third base portion 231 beyond a root of the third elastic arm 232 to the third base portion. This facilitates alignment with the spacer rib 13 and also reduces mutual interference between the elastic arms on both longitudinal sides.

Furthermore, the first terminal piece 21 has a first connecting portion 216 extending from the first base portion and a plurality of first pins 217 extending from the first connecting portion. The second terminal piece 22 has a second connecting portion 226 extending from the second base portion and a plurality of second pins 227 extending from the second connecting portion. The third terminal piece 23 has a third connecting portion 236 extending from the third base portion and a plurality of third pins 237 extending from the third connecting portion. The first, second, and third connecting portions are exposed on the outside of a rear end of the insulating housing 10, and the first, second, and third pins are used for insertion into the circuit board.

Furthermore, the first connecting portion 216 has a first vacant slot 218 aligned with one of the first vacant portions 215A. The second connecting portion 226 has a second vacant slot 228 aligned with the second vacant portion 235. The third connecting portion 236 has a third vacant slot 238 aligned with the third vacant portion 235 in the mating direction. The vacant slots help to reduce mutual linkage between the pins on both longitudinal sides.

Furthermore, the third base portion has a plurality of fixing posts 239 inserted into fixing holes 229 and 219 formed in the second and first base portions, respectively, thereby connecting the individual separated terminal pieces into an integral unit.

In more detail, in this embodiment, the first terminal piece 21 comprises six first elastic arms 212. The second terminal piece comprises ten second elastic arms 222, 223 divided into two groups in the longitudinal direction by the second vacant portion 225, the two groups are mirror symmetry with each other. The two second elastic arms 222 located on both longitudinal sides of the second vacant portion 225 are laterally aligned with each other, while the other adjacent second elastic arms 223 are laterally offset from each other and arranged in two rows. The third terminal piece 23 comprises ten third elastic arms 232, 233 divided into two groups in the longitudinal direction by the third vacant portion 235, the two groups are mirror symmetry with each other. The two third elastic arms 232 located on both longitudinal sides of the third vacant portion 235 are laterally aligned with each other, while the other adjacent third elastic arms 233 are laterally offset from each other and arranged in two rows.

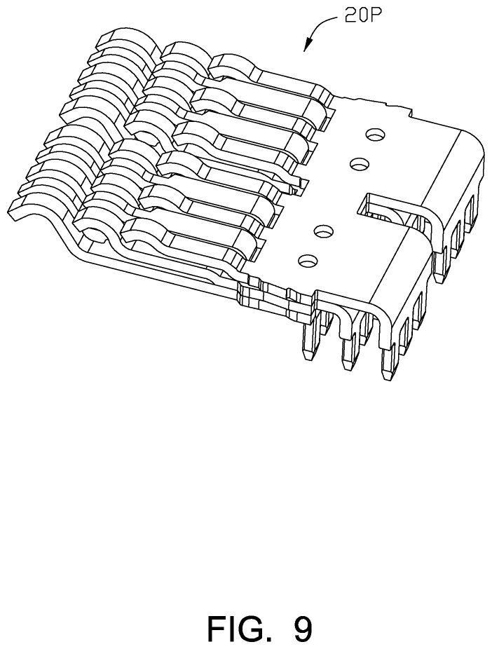

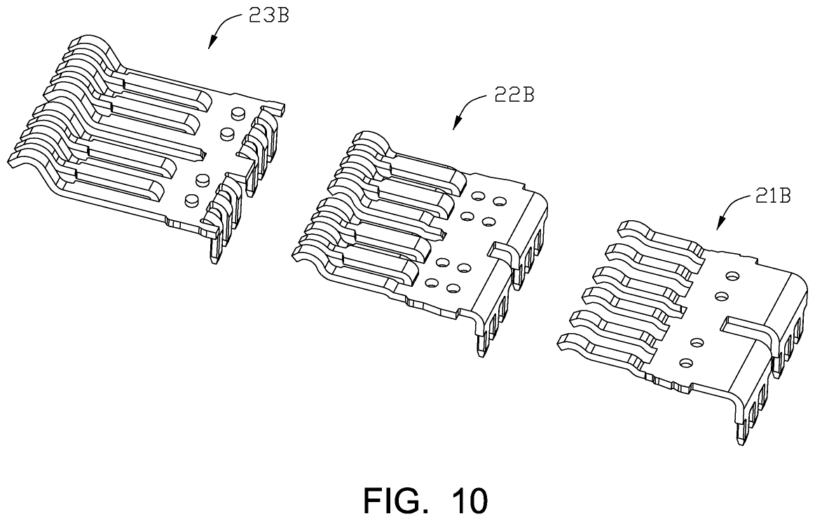

FIGS. 9-11 show the structure of the lower power terminal 20P. The design principle of the lower power terminal 20P is basically the same as that of the upper power terminal. The lower power terminal 20P has a first terminal piece 21B, a second terminal piece 22B, and a third terminal piece 23B. The main differences from the upper power terminal lie in the connecting portion and the pins, and therefore will not be described in detail here.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing having a mating slot extending in a first direction and defining a mating direction; and
at least one power terminal disposed on one side of the mating slot along a second direction perpendicular to the first direction and comprising a first terminal piece, a second terminal piece, and a third terminal piece; wherein
the first terminal piece comprises a first base portion, a plurality of first elastic arms extending from the first base portion, and a respective first contact portion curvedly bent from a distal end of each of the first elastic arms;
the second terminal piece comprises a second base portion, a plurality of second elastic arms extending from the second base portion, and a respective second contact portion curvedly bent from a distal end of each of the second elastic arms;
the third terminal piece comprises a third base portion, a plurality of third elastic arms extending from the third base portion, and a respective third contact portion curvedly bent from a distal end of each of the third elastic arms;
the first base portion, the second base portion, and the third base portion are stacked in the second direction and fixed in the insulating housing;
the first contact portions are arranged in a row, the second contact portions are arranged in a row, and the third contact portions are arranged in a row;
the second contact portions are located inside the third contact portions in the mating direction and aligned one-to-one with the third contact portions;
the first contact portions are located inside the second contact portions in the mating direction and each of the first contact portions is aligned with one of two adjacent second contact portions; and
a spacing between adjacent first elastic arms is greater than a width of the second elastic arm in the first direction.

2. The electrical connector as claimed in claim 1, wherein:
a first vacant portion is located between two adjacent first elastic arms;
the second elastic arms are divided into two groups in the first direction by a second vacant portion therebetween;
the third elastic arms are divided into two groups in the first direction by a third vacant portion therebetween;
a width of the first vacant portion is greater than a spacing between adjacent second elastic arms in the first direction;
a width of the third vacant portion is greater than a spacing between adjacent third elastic arms in the first direction; and
one of two adjacent first vacant portions, the second vacant portion, and the third vacant portion are aligned with each other in the second direction.

3. The electrical connector as claimed in claim 2, wherein the insulating housing has a spacing rib positioned within the second vacant portion, the third vacant portion, and one of two adjacent first vacant portions.

4. The electrical connector as claimed in claim 3, wherein the second vacant portion is recessed toward the second base portion beyond a root of the second elastic arm to the second base portion, and the third vacant portion is recessed toward the third base portion beyond a root of the third elastic arm to the third base portion.

5. The electrical connector as claimed in claim 4, wherein a middle one of the first vacant portions is recessed toward the first base portion beyond a root of the first elastic arm to the first base portion.

6. The electrical connector as claimed in claim 4, wherein:
the first terminal piece has a first connecting portion extending from the first base portion and a plurality of pins extending from the first connecting portion;
the second terminal piece has a second connecting portion extending from the second base portion and a plurality of pins extending from the second connecting portion; and
the third terminal piece has a third connecting portion extending from the third base portion and a plurality of pins extending from the third connecting portion.

7. The electrical connector as claimed in claim 6, wherein:
the first connecting portion has a first vacant slot;
the second connecting portion has a second vacant slot aligned with the second vacant portion;
the third connecting portion has a third vacant slot aligned with the third vacant portion; and
the first vacant slot and the second vacant slot are aligned with each other in the second direction.

8. The electrical connector as claimed in claim 7, wherein:
a gap between any adjacent second elastic arms is close to zero in the first direction, and adjacent second elastic arms are offset in the second direction and arranged in two rows;
a gap between any adjacent third elastic arms is close to zero in the first direction, and adjacent third elastic arms are offset in the second direction and arranged in two rows; and
the second elastic arms and the third elastic arms are aligned one-to-one in the second direction.

9. The electrical connector as claimed in claim 4, wherein one of each pair of adjacent second elastic arms is aligned one-to-one with the first elastic arms in the second direction.

10. The electrical connector as claimed in claim 9, wherein the other one of each pair of adjacent second elastic arms extends between two first elastic arms in the second direction.

11. The electrical connector as claimed in claim 1, wherein:
the first terminal piece has six first elastic arms; and
the second terminal piece has ten second elastic arms divided into two groups in the first direction by a second vacant portion, the two second elastic arms located on opposite sides of the second vacant portion are aligned with each other in the second direction, and the other adjacent second elastic arms are offset from each other in the second direction and arranged in two rows.

12. The electrical connector as claimed in claim 11, wherein the third terminal piece has ten third elastic arms divided into two groups in the first direction by a third vacant portion, the two third elastic arms located on opposite sides of the third vacant portion are aligned with each other in the second direction, and the other adjacent third elastic arms are offset from each other in the second direction and arranged in two rows.

13. A power terminal comprising:
a first terminal piece having a first base portion, a plurality of first elastic arms extending forward from the first base portion, and a respective first contact portion curved from each of the first elastic arms;
a second terminal piece having a second base portion, a plurality of second elastic arms extending forward from the second base portion, and a respective second contact portion curved from each of the second elastic arms; and
a third terminal piece having a third base portion, a plurality of third elastic arms extending forward from the third base portion, and a respective third contact portion curved from each of the third elastic arms; wherein
the plurality of first contact portions are arranged in a rear row in a first direction, the plurality of second contact portions are arranged in a middle row, and the plurality of third contact portions are arranged in a front row;
the first base portion, the second base portion, and the third base portion are stacked in a second direction perpendicular to the first direction;
the second contact portions are aligned one-to-one with the third contact portions;
the first contact portions are aligned with corresponding second contact portions respectively; and
a spacing between adjacent first elastic arms is greater than a width of the second elastic arm in the first direction.

14. The power terminal as claimed in claim 13, wherein:
a first vacant portion is located between two adjacent first elastic arms;
the plurality of second elastic arms are divided into two groups in the first direction by a second vacant portion therebetween;
the plurality of third elastic arms are divided into two groups in the first direction by a third vacant portion therebetween;
a width of the first vacant portion is greater than a spacing between adjacent second elastic arms in the first direction;
a width of the third vacant portion is greater than a spacing between adjacent third elastic arms in the first direction; and
one of the first vacant portions, the second vacant portion, and the third vacant portion are aligned with each other in the second direction.

15. An electrical connector comprising:
an insulating housing having a mating slot opening forward in a mating direction; and
two power terminals disposed on opposite sides of the mating slot along a second direction and each of the two power terminals comprising a first terminal piece, a second terminal piece, and a third terminal piece stacked in the second direction;
wherein:
the first terminal piece comprises a plurality of first elastic arms each with a first contact portion curved towards the mating slot;
the second terminal piece comprises a plurality of second elastic arms arranged in a first direction and each with a second contact portion curved towards the mating slot;
the third terminal piece comprises a plurality of third elastic arms each with a third contact portion curved towards the mating slot;
the first contact portions are arranged in a rear row, the second contact portions are arranged in a middle row, and the third contact portions are arranged in a front row in the mating direction; and
the second contact portions are aligned with the third contacting portion one by one, and the first contact portions are aligned with corresponding second contact portions.

16. The electrical connector as claimed in claim 15, wherein:
the second elastic arms are divided into two groups in mirror-image symmetry with each other in the first direction, and every two adjacent second elastic arms of each group are offset from each other in the second direction so as to be arranged in two rows; and
the third elastic arms are divided into two groups in mirror-image symmetry with each other in the first direction, and every two adjacent third elastic arms of each group are offset from each other in the second direction so as to be arranged in two rows.

17. The electrical connector as claimed in claim 16, wherein the first elastic arms are arrange in a row and are divided into two groups in mirror-image symmetry with each other in the first direction.
